(19) United States
(12) Patent Application Publication
(10) Pub. No.: US 2024/0125097 A1
(43) Pub. Date: Apr. 18, 2024

(54) EARTHMOVING VEHICLE PERFORMANCE MONITORING

(71) Applicant: CEPTION TECHNOLOGIES LTD., Jerusalem (IL)

(72) Inventors: Yossef Israel BUDA, Kfar-Adumim (IL); Tal Israel ISRAEL, Mazkeret-Batya (IL)

(73) Assignee: CEPTION TECHNOLOGIES LTD., Jerusalem (IL)

(21) Appl. No.: 18/277,379

(22) PCT Filed: Feb. 17, 2022
(86) PCT No.: PCT/IL2022/050189

§ 371 Date: Aug. 15, 2023

Related U.S. Application Data
(60) Provisional application No. 63/150,591, filed on Feb. 18, 2021.

(51) Int. Cl. E02F 9/26; G01C 21/00; G07C 5/02

(52) U.S. Cl. CPC E02F 9/261; G01C 21/3826; G01C 21/3848; G07C 5/02

(57) ABSTRACT

An earthmoving vehicle performance monitoring system includes one or a plurality of sensors for mounting on an earthmoving vehicle. A processor is configured to receive sensed data generated by the sensors when mounted on the vehicle and when the vehicle is excavating in a region which the vehicle is tasked with excavating, to analyze the sensed data to update a topographical map of the region, and to analyze changes to the topographical map due to the updating to calculate a volume of earth that was excavated by the vehicle.

### FIELD OF THE INVENTION

The present invention relates to earthmoving vehicles. More particularly, the present invention relates to a system and method of monitoring performance of an earthmoving vehicle.

### BACKGROUND OF THE INVENTION

At a typical mining or construction site, various earthmoving vehicles, such as bulldozers, graders, or similar vehicles, are tasked with excavating a region of the site. Typically, the earthmoving vehicles push a quantity of earth (e.g., composed of soil, sand, rocks, or other materials, e.g., after being loosened by blasting) to remove the earth from an area to be excavated.

The earth that is removed from the excavation is typically pushed to a region outside of the excavation where heaps or piles are formed by the removed earth. Typically, the removed earth is loaded by loaders onto trucks or other carriers for removal. For example, at a construction site, the loaded earth may be transported to a dumping site where the earth is disposed of by dumping. At a mining site, removed earth that is expected to contain a mined material may be transported to a processing site where the mined material is separated from the earth.

### SUMMARY OF THE INVENTION

There is thus provided, in accordance with an embodiment of the invention, an earthmoving vehicle performance monitoring system including: one or a plurality of sensors for mounting on an earthmoving vehicle; and a processor that is configured to: receive sensed data generated by the sensors when mounted on the vehicle and when the vehicle is excavating in a region which the vehicle is tasked with excavating; analyze the sensed data to update a topographical map of the region; and analyze changes to the topographical map due to the updating to calculate a volume of earth that was excavated by the vehicle.

Furthermore, in accordance with an embodiment of the invention, the sensors are selected from a group of sensors consisting of a camera, radar scanner and lidar scanner.

Furthermore, in accordance with an embodiment of the invention, the processor is configured to analyze image data that is acquired by the sensors to determine a location or orientation of a part of the vehicle relative to a reference feature.

Furthermore, in accordance with an embodiment of the invention, the processor is configured to analyze the image data by application of simultaneous localization and mapping (SLAM) techniques to the image data.

Furthermore, in accordance with an embodiment of the invention, the processor is configured to update the topographical map by utilizing the location or orientation of the part of the vehicle and dimensions of the vehicle to calculate a height or slope of ground under the vehicle.

Furthermore, in accordance with an embodiment of the invention, the sensors include one or more navigation sensors selected from a group of sensors consisting of a global navigation satellite system (GNSS) receiver, an inertial measurement unit (IMU), a compass, a speedometer, an odometer, an altimeter and a tilt sensor.

Furthermore, in accordance with an embodiment of the invention, the processor is configured to analyze data received from the navigation sensors to determine one or more kinematic characteristics selected from a group of kinematic characteristics consisting of a location of the vehicle, an orientation of the vehicle, a velocity of the vehicle and an acceleration of the vehicle.

Furthermore, in accordance with an embodiment of the invention, the processor is configured to analyze data received from the navigation sensors to determine a location or orientation of a part of the vehicle.

Furthermore, in accordance with an embodiment of the invention, the processor is configured to update the topographical map by utilizing the determined location or orientation of the part of the vehicle and dimensions of the vehicle to calculate a height or slope of ground under the vehicle.

Furthermore, in accordance with an embodiment of the invention, the processor is configured to apply SLAM techniques to data that is received from the navigation sensors to update the topographical map.

Furthermore, in accordance with an embodiment of the invention, the sensors include one or more operation sensors that are configured to sense one or more characteristics of operation of the vehicle selected from a group of operation characteristics consisting of fuel consumption by the vehicle, rate of rotation of an engine of the vehicle, a gear ratio of a transmission of the vehicle, a steering angle of the vehicle, application of brakes of the vehicle and a position of an earthmoving blade of the vehicle.

Furthermore, in accordance with an embodiment of the invention, the processor is configured to analyze the data received from the operation sensors to determine when the vehicle is engaged in moving earth.

Furthermore, in accordance with an embodiment of the invention, the processor is configured to calculate a fraction of a time period during which the vehicle is engaged in moving earth.

There is further provided, in accordance with an embodiment of the invention, a method for monitoring performance of an earthmoving vehicle, the method including: receiving sensed data that is generated by sensors that are mounted on the vehicle when the vehicle is excavating in a region that the vehicle is tasked with excavating; analyzing the sensed data to update a topographical map of the region; and analyzing changes to the topographical map due to the updating to calculate a volume of earth that was excavated by the vehicle.

Furthermore, in accordance with an embodiment of the invention, receiving the sensed data includes receiving data from sensors selected from a group of sensors consisting of a camera, radar scanner and lidar scanner.

Furthermore, in accordance with an embodiment of the invention, analyzing the sensed data to update the topographical map includes analyzing image data that is acquired by the sensors to determine a location or orientation of a part of the vehicle relative to a reference feature, and utilizing the determined location or orientation of the part of the vehicle and dimensions of the vehicle to calculate a height or slope of ground under the vehicle.

Furthermore, in accordance with an embodiment of the invention, receiving the sensed data includes receiving the sensed data from one or more operation sensors that are configured to sense one or more characteristics of operation of the vehicle selected from a group of operation characteristics consisting of fuel consumption by the vehicle, rate of rotation of an engine of the vehicle, a gear ratio of a transmission of the vehicle, a steering angle of the vehicle, application of brakes of the vehicle and a position of an earthmoving blade of the vehicle.

Furthermore, in accordance with an embodiment of the invention, the method includes analyzing the data received from the operation sensors to determine when the vehicle is engaged in moving earth and calculating a fraction of a time period during which the vehicle is engaged in moving earth.

Furthermore, in accordance with an embodiment of the invention, receiving the sensed data includes receiving the sensed data from one or more navigation sensors selected from a group of sensors consisting of a GNSS receiver, an IMU, a compass, a speedometer, an odometer, an altimeter and a tilt sensor.

Furthermore, in accordance with an embodiment of the invention, analyzing the sensed data to update the topographical map includes analyzing the data received from the navigation sensors to determine a location or orientation of a part of the vehicle and utilizing the determined location or orientation and dimensions of the vehicle to calculate a height or slope of ground under the vehicle.

### BRIEF DESCRIPTION OF THE DRAWINGS

In order for the present invention to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates an earthmoving vehicle configured for monitoring by a vehicle monitoring system, in accordance with an embodiment of the invention.

FIG. 2 is a schematic block diagram of an example of a vehicle-mounted module for communication with the vehicle monitoring system.

FIG. 3 is a schematic block diagram of a processor of a vehicle monitoring system, in accordance with an embodiment of the invention.

FIG. 4 schematically illustrates an example of monitoring a volume of earth that is excavated by the earthmoving vehicle shown in FIG. 1.

FIG. 5 is a flowchart depicting a method of operation of a vehicle monitoring system to determine a volume of earth that is excavated by an earthmoving vehicle, in accordance with an embodiment of the invention.

FIG. 6 is a flowchart depicting a method of operation of a vehicle monitoring system to monitor performance of an earthmoving vehicle, in accordance with an embodiment of the invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, the conjunction “or” as used herein is to be understood as inclusive (any or all of the stated options).

Some embodiments of the invention may include an article such as a computer or processor readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

In accordance with an embodiment of the invention, a vehicle monitoring system is configured to monitor operation of one or more earthmoving vehicles that are operating in a region of a worksite. Typically, each earthmoving vehicle is tasked with excavating a particular region, e.g., defined by boundaries, landmarks, or otherwise. Where the ground consists of bedrock or other masses of material that are too hard or massive to be excavated by the earthmoving vehicle, the ground may be broken up by blasting, hammering, or otherwise, to enable the earthmoving vehicle to excavate the ground.

A processor of the vehicle monitoring system is configured to calculate the values of one or more metrics that may be used to rate performance of an earthmoving vehicle, the operator of the earthmoving vehicle, or both. For example, performance may include the quality or quantity of work that is done by each earthmoving vehicle, or the skill or behavior of an operator of each earthmoving vehicle.

Each earthmoving vehicle that is monitored by the vehicle monitoring system may be provided with one or more sensors mounted on the vehicle. Alternatively or in addition, sensors may be mounted at various locations within, around, or above a region in which the earthmoving vehicle is expected to operate. For example, sensors may be placed on the ground, on towers or other raised platforms or structures, on balloons, on unmanned areal vehicles (UAV), or otherwise in the vicinity of the region.

The sensors are configured to sense one or more quantities that may be analyzed to map a region which the earthmoving vehicle is tasked with excavating. Alternatively or in addition, the sensors may be configured to sense one or more quantities that may be analyzed to evaluate performance of the earthmoving vehicle, or of an operator of the earthmoving vehicle.

The sensors may include navigation sensors that monitor the position or motion of the earthmoving vehicle. For example, navigation sensors may include a receiver for a global navigation satellite system (GNSS) such as the Global Positioning System (GPS), an inertial measurement unit (IMU), compass, speedometer, odometer, altimeter, or other navigation sensors. Sensors may include one or vehicle-mounted or otherwise mounted cameras or other imagers that are configured to acquire images that may be analyzed by the vehicle monitoring system to yield a map of the region that the earthmoving vehicle is tasked with excavating. Sensors may include radar, lidar, or fixed or scanning rangefinders that may be operated to map the topography of a region in the vicinity of the earthmoving vehicle. Sensors may include sensors that sense various characteristics of operation of the earthmoving vehicle, e.g., as a function of time. Such characteristics may include, for example, speed, acceleration, speed of engine rotation (tachometer reading), steering angle, gear shifts, blade position (e.g., raised or lowered), or other characteristics of vehicle operation.

For example, the system (e.g., a computer or processor of the vehicle monitoring system) may receive and analyze readings from the navigation sensors, the vehicle operation sensors, or both, during operation of the earthmoving vehicle. The analysis may create a map of the topography of a region that is being excavated by the earthmoving vehicle, modify a previously created topography map, or both. The system may store a map for reference at one or more fixed or variable times. For example, a topographical map of ground height as a function of position may be recorded at the end of each workday, or at one or more other times. The position may be defined in accordance one or more local, regional, or global (e.g., latitude and longitude, or other global) coordinate systems. Similarly, the height may be expressed relative to the altitude of a selected landmark or other selected reference altitude, as a globally recognized height standard (e.g., relative to nominal sea level or distance from the center of the earth), or otherwise.

Among the monitored metrics is the volume of earth that was excavated by the monitored earthmoving vehicle, e.g., per workday or during another period of time. For example, during the course of work by the earthmoving vehicle, the sensors may continually or periodically sense any changes in height at various points of the region that the earthmoving vehicle is assigned to excavate. At one or more predetermined times, typically including the end of a workday, an updated map may be compared with a previous map. Analysis of the difference between the maps may yield a volume of earth that was removed from a region. For example, a numerical sum or integration of mapped differences over the region may be calculated to indicate the volume of earth that was moved.

Other monitored metrics may relate to efficiency of operation of the earthmoving vehicle. For example, sensor data that is received from vehicle operation sensors may be analyzed to determine an indication of efficiency of operation of the vehicle. Analysis of the sensor data may indicate when the earthmoving vehicle is moving earth and when it is operating without moving earth. For example, excavation of moving of earth may be indicated by a combination of one or more sensed characteristics, such as a lowered blade, increased engine output (e.g., as measured by engine rotation, fuel consumption, or another indication of engine output), gear ratio of a transmission of the earthmoving vehicle, or another indication of increased load. The system may then calculate a fraction of a period during which the earthmoving vehicle is engaged in earthmoving activity (e.g., as opposed to idling or moving from one point to another).

Analysis of both efficiency of operation and the volume of earth that that is excavated may indicate a degree of skill of the operator of the earthmoving vehicle.

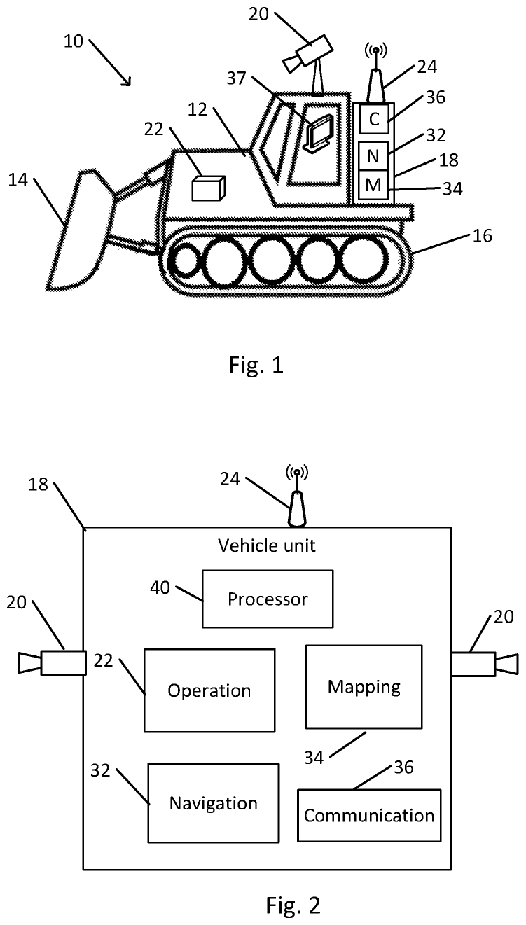

FIG. 1 schematically illustrates an earthmoving vehicle configured for monitoring by a vehicle monitoring system, in accordance with an embodiment of the invention. FIG. 2 is a schematic block diagram of an example of a vehicle-mounted module for communication with the vehicle monitoring system.

In the example shown, earthmoving vehicle 10 is configured to operate in coordination with a vehicle monitoring system. A typical earthmoving vehicle 10 includes a vehicle body 12 and motorized propulsion mechanism 16 (typically including tracks, as in the example shown, tires, or another motorized propulsion mechanism). Earthmoving vehicle 10 is provided with an earthmoving blade 14. Typically, earthmoving blade 14 may be lowered when earthmoving vehicle 10 is operating to excavate a region or otherwise move earth from one place to another. (As used herein, “earth” refers to a fragmented material that is part of, or has been deposited on, the surface of the ground, such as soil, rocks, sand, or other material.) Earthmoving blade 14 may be raised when earthmoving vehicle 10 is travelling from one location to another without moving earth. Earthmoving vehicle 10 may be in the form of a bulldozer (as indicated schematically in FIG. 1), a grader, or other type of vehicle that is provided with the capability of moving earth from one place to another.

Earthmoving vehicle 10 includes a vehicle module 18 that is mounted on or incorporated into earthmoving vehicle 10.

Vehicle module 18 may include a monitoring system processor 40 that is configured to control operation of, and receive data signals from, one or more sensors.

Alternatively or in addition, some or all components (e.g., processing units) of monitoring system processor 40 may be located at a remote location, e.g., at a central server of the vehicle monitoring system, at a location at the worksite, at various remote locations (e.g., cloud computing), or elsewhere. In this case, a remote component of monitoring system processor 40 may communicate with vehicle module 18 via a communications module 36 that enables monitoring system processor 40 to communicate with vehicle module 18 via wireless communications channel 24.

Vehicle module 18 includes, or monitoring system processor 40 is configured to communicate with, one or more sensors. Each sensor is configured to generate a signal that is indicative of a quantity or data that is sensed by that sensor. For the purpose of this description, the sensors are categorized as vehicle operation sensors 22, navigation sensors 32, and mapping sensors 34. (The division of sensors into these categories as described below has been selected for simplicity of the description. Sensors may be alternatively divided otherwise into categories, and particular sensors may be alternatively assigned to a different category than as described below, or may be assigned to two or more categories.)

Typically, sensors of vehicle module 18 include one or more vehicle operation sensors 22 that monitor operation of various components of earthmoving vehicle 10. For example, one or more sensors of vehicle operation sensors 22 may monitor performance of an engine of earthmoving vehicle 10 (e.g., rate of fuel consumption, rate of engine rotation, power output, composition of exhaust gasses, or another characteristic of engine operation). One or more sensors of vehicle operation sensors 22 may monitor characteristics of vehicle operation such as gear ratio, rate of wheel rotation, steering angle, application of brakes, position of earthmoving blade 14 (e.g., raised or lowered), operation of controls by an operator of earthmoving vehicle 10, or other characteristics of vehicle operation.

Sensors of vehicle module 18 may include one or more navigation sensors 32 that are configured to sense one or more indications of one or more kinematic characteristics of earthmoving vehicle 10. Kinematic characteristics may include a location of earthmoving vehicle 10, an orientation of earthmoving vehicle 10, or movement of earthmoving vehicle 10 (e.g., vector velocity or acceleration). For example, navigation sensors 32 may include an odometer, a receiver for a GNSS (e.g., GPS), an IMU, a compass, a speedometer, an altimeter, a tilt sensor, or other navigation sensors. Navigation sensors 32 may be configured to apply real-time kinematic positioning (RTK) technology in order to enhance localization by a GNSS.

Sensors of vehicle module 18 may include one or more mapping sensors 34 that are configured to generate a three-dimensional map of a region that is being excavated by earthmoving vehicle 10. For example, mapping sensors 34 may include one or more fixed or rotatable (e.g., with controlled pan and tilt) imaging devices 20 (e.g., video cameras, stereo cameras, still cameras, or other cameras for imaging visible light or radiation in another wavelength range) whose orientation relative to earthmoving vehicle 10 is known or measurable (e.g., by one or more angle sensors). Monitoring system processor 40 may be configured to analyze images that are acquired by one or more imaging devices 20 to three-dimensionally map surfaces within a line of sight from earthmoving vehicle 10. Mapping sensors 34 may include one or more fixed or scannable range-finding devices (e.g., based on radar, lidar, echolocation, or other wise) that may measure distances to a surface or object, and thus map surfaces that surround earthmoving vehicle 10.

It may be noted that monitoring system processor 40 may be configured to utilize data from both navigation sensors 32 and mapping sensors 34 to determine a location and orientation of vehicle module 18.

For example, simultaneous localization and mapping (SLAM) techniques, e.g., visual SLAM techniques or other techniques, may be applied to images that are acquired by imaging devices 20 to concurrently map a region surrounding earthmoving vehicle 10 and determine the location of earthmoving vehicle 10 within the mapped region.

For example, one or more landmarks or topographical features may identified as fixed reference features that are not expected to change during the course of excavation by earthmoving vehicle 10. The reference features may be identified (e.g., by a human operator or automatically by application of image processing and analysis to images and matching the images to a topographical map of the region) in images that are acquired by imaging devices 20. Analysis of subsequently acquired images in which one or more reference features are visible (or images that are acquired after an imaging device has been subjected to a known translation or rotation after having acquired an image in which the reference feature is visible) may yield a location, orientation, or both of an imaging device 20 relative to the reference feature.

Knowledge of the location of imaging device 20 relative to the bottom of earthmoving vehicle 10 (e.g., taking the bottom to be a plane that is defined by the tracks of propulsion mechanism 10), and assuming that earthmoving vehicle 10 is upright, may enable calculation of the height of the ground under the bottom of earthmoving vehicle 10. When analysis of the images yields an orientation of earthmoving vehicle 10 (e.g., pitch and roll angles relative to the horizontal and azimuth angle relative to a fixed direction, or another representation of orientation of earthmoving vehicle 10), the orientation information may be utilized to calculate a more accurate topographical mapping (e.g., height and slope) of the ground under the bottom of earthmoving vehicle 10.

As another example, analysis of data that is acquired from various navigation sensors 32, such as from a GNSS receiver, an IMU, or an odometer, or from another navigation sensor 32, may yield changes in a map along a route that was travelled by earthmoving vehicle 10, e.g., during excavation. For example, analysis of information that is acquired using one or more navigation sensors 32, imaging devices 20, or other sensors, may yield a three-dimensional location of a part of earthmoving vehicle 10 (e.g., a location of the sensor on earthmoving vehicle 10).

Knowledge of the location of the part relative to the bottom of earthmoving vehicle 10, and assuming that earthmoving vehicle 10 is upright, may enable calculation of the height of the ground under the bottom of earthmoving vehicle 10. When analysis of the information that is acquired by the sensors yields an orientation of earthmoving vehicle 10, the orientation information may be utilized to calculate a more accurate topographical mapping of the ground under the bottom of earthmoving vehicle 10.

Vehicle module 18 may include one or more output devices 37 that are configured to communicate information to an operator of earthmoving vehicle 10. For example, monitoring system processor 40 may generate one or more visible or audible signals that may convey information, e.g., based on analysis of data from one or more sensors, to the operator. For example, output devices may include one or more display screens, signal lights, speakers, bells, buzzers, sirens, or other devices that may convey information. The information may include detection of a situation that is potentially harmful to the safety or wellbeing of the operator, to earthmoving vehicle 10, to operation of earthmoving vehicle 10, or to other vehicles, personnel, or structures. The information may include indications of proper or efficient operation of earthmoving vehicle 10, an optimal route for travel, evaluation of performance of earthmoving vehicle 10 (e.g., in real time during the course of operation), or other results of analysis of sensor data. The information may include performance data or metrics that may be reviewed by one or more of an operator of earthmoving vehicle 10, a supervisor of the worksite, a manager of the operator of earthmoving vehicle 10, vehicle maintenance personnel, or another party.

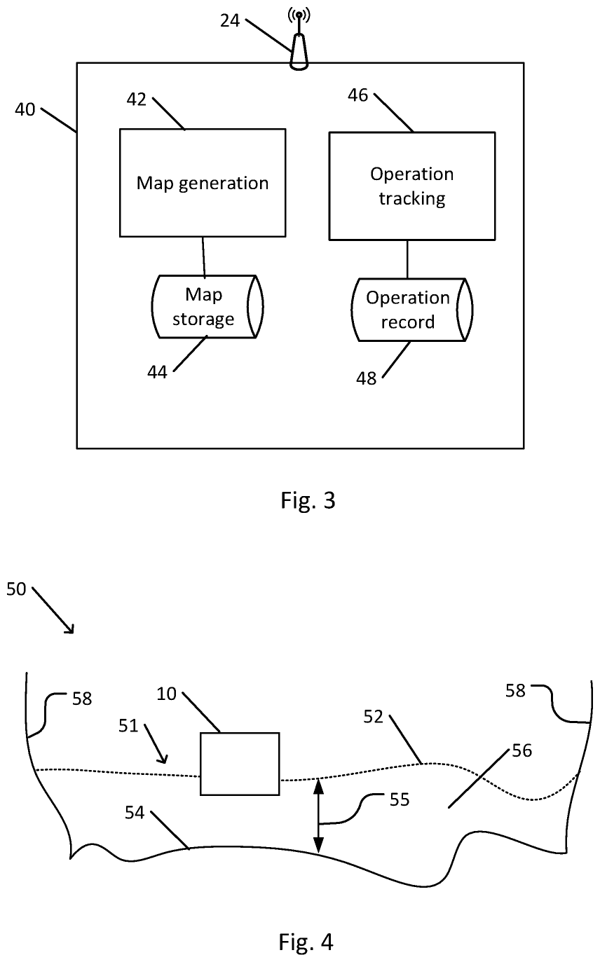

FIG. 3 is a schematic block diagram of a processor of a vehicle monitoring system, in accordance with an embodiment of the invention.

Monitoring system processor 40 of the vehicle monitoring system includes a processor that is configured to execute functionality of one or more processing modules (e.g., programs or other software units, firmware or hardware devices, or another type of processing module). It may be noted that the division of functionality of monitoring system processor 40 into separate modules is for convenience of the discussion only, and that the functionality may be otherwise divided among modules, or may be described as a single module.

In some cases, monitoring system processor 40 (e.g., that is located remotely from vehicle module 18) may be configured to receive signals from sensors of vehicle modules 18 of one or more earthmoving vehicles 10 that are associated with the vehicle monitoring system. For example, monitoring system processor 40 may receive via wireless communications channel 24 sensor data, vehicle and operator identification data, or other data that is transmitted by one or more vehicle modules 18.

In some examples, monitoring system processor 40 may represent a single processing unit or computer that is located at a single location (e.g., on earthmoving vehicle 10, at a worksite where one or more earthmoving vehicles 10 are operating, at a central location that is communication with earthmoving vehicles 10 at one or more worksites, or elsewhere). In other examples, monitoring system processor 40 may represent a plurality of intercommunicating processing units or computers that may be located at a single location, or at a plurality of locations (e.g., cloud computing). For example, monitoring system processor 40 may represent a worksite server that is located at a worksite and that communicates with a server at a remote or central location. Functionality of monitoring system processor 40 may thus be divided among several processing units.

Functionality of monitoring system processor 40 may include a map generation module 42. Map generation module 42 may include software that executes on a processor of monitoring system processor 40, hardware or firmware that is configured to provide the functionality of map generation module 42, or both.

Map generation module 42 may be configured to analyze sensor data that is received from one or both of navigation sensors 32 and mapping sensors 34 to generate a three-dimensional map of a region in which one or more earthmoving vehicles 10 are operating. For example, map generation module 42 may generate a map of a region that a particular earthmoving vehicle 10 is assigned to excavate. A three-dimensional map of a mapped region may be stored in map storage 44 (e.g., on one or more memory storage units or facilities that are associated with monitoring system processor 40).

In some examples, map generation module 42 may be configured to generate an initial map of a region (e.g., applying one or more image processing techniques to image data that is acquired by imaging devices 20, SLAM technology to data from navigation sensors 32, using data from range-finding scanners or other mapping sensors 34, or other techniques). The initial map may be stored in map storage 44.

For example, prior to beginning excavation, e.g., after blasting operations have loosened the earth in the region to be excavated, earthmoving vehicle 10 may travel in a pattern that is configured to enable the sensors on earthmoving vehicle 10 to acquire sufficient information to enable map generation module 42 to generate an initial map. Alternatively or in addition, an initial map may generated by scanning the region using sensors that are external to vehicle module 18. For example, sensors mounted on a drone, aircraft, satellite, vehicle, or elevation near the region to be excavated may be utilized to generate the initial map. Alternatively or in addition, a detailed topographical map of the region may be acquired from an external source.

During continued operation of earthmoving vehicle 10 in a region, the stored map may be continually updated using continually received sensor data, and the updated map stored in map storage 44, e.g., accompanied by a time stamp indicating when the map was updated. In other examples, updated map data may be stored in map storage 44 at predetermined intervals, in response to predetermined conditions (e.g., end of a workday or shift, predetermined amount of change, or other conditions), in response to a command that is generated by an operator of the vehicle monitoring system or of earthmoving vehicle 10, or otherwise. In some cases, a map may be continually updated in a temporary memory, e.g., of monitoring system processor 40, of vehicle module 18, or elsewhere, until a final version is stored (e.g., at the end of a workday, work shift, or other time) in map storage 44.

Functionality of monitoring system processor 40 may include operation tracking module 46. Operation tracking module 46 may include software that executes on a processor of monitoring system processor 40, hardware or firmware that is configured to provide the functionality of operation tracking module 46, or both.

Operation tracking module 46 may be configured to analyze sensor data that is received from one or more of vehicle operation sensors 22, navigation sensors 32, and mapping sensors 34 to calculate the value of one or more parameters or metrics that characterize or rate operation of earthmoving vehicle 10. The calculated values may enable evaluation of operation of an earthmoving vehicle 10 against operation of other earthmoving vehicles 10 (operating at a single or at multiple worksites), against the same earthmoving vehicle 10 when operated by another operator, or against one or more predetermined goals or standards.

For example, operation tracking module 46 may be configured to distinguish between times that earthmoving vehicle 10 is being operated to excavate or move earth, and times when earthmoving vehicle 10 is idling, or is travelling from one location to another without moving earth. The fraction of a total time of operation of earthmoving vehicle 10 in which earthmoving vehicle 10 is actually moving earth may be indicative a level of skill or diligence of the operator of earthmoving vehicle 10.

Analysis by operation tracking module 46 of one or more characteristics of operation of earthmoving vehicle 10 as sensed by vehicle operation sensors 22, navigation sensors 32, or both may indicate when earthmoving vehicle 10 is moving earth. Indications of moving earth may include, for example, lowering of earthmoving blade 14 (e.g., below a predetermined tilt angle above the horizontal), increased engine effort (e.g., detectable by one or more of increased rate of fuel consumption, increased rate or engine rotation (e.g., as measured by a tachometer), increased gear ratio, increased rotation of a fan for engine cooling, reduced rotation rate of tires or tracks relative to engine rotation, or otherwise), increased stress on earthmoving blade 14 or on propulsion mechanism 16, or other indications. In some cases, analysis of images that are acquired by imaging devices 20 may indicate whether or not earthmoving blade 14 is lowered, is engaged in moving earth, or both.

Starting times and endings times of periods when earthmoving vehicle 10 is engaged in moving earth may be stored in operation tracking record 48. Alternatively or in addition, durations of periods during which earthmoving vehicle 10 is engaged in moving earth, may be stored in operation tracking record 48. For example, operation tracking record 48 may be stored on a data storage device that is in communication with a processor of monitoring system processor 40. The data storage device may include a volatile or nonvolatile, fixed or removable, local or remote, data storage device or memory. The data storage device may include cloud storage at a plurality of remote locations that are accessible via a network.

Similarly, analysis by operation tracking module 46 of one or more characteristics of operation of earthmoving vehicle 10 as sensed by vehicle operation sensors 22, navigation sensors 32, or both may indicate when earthmoving vehicle 10 is in operation (e.g., with an engine running) or is in motion from one location to another. Periods of time that earthmoving vehicle 10 may also be stored in operation tracking record 48.

Operation tracking module 46 may be configured to compare a duration of periods when earthmoving vehicle 10 is engaged in moving earth with a duration of periods in which earthmoving vehicle 10 is operating to yield a value of a metric of operation efficiency. For example, comparison may yield a score that is based on a fraction of total operation time during which earthmoving vehicle 10 is engaged in moving earth. The score for a particular earthmoving vehicle 10 when operated by a particular operator may be compared with a reference score. For example, the reference score may be based on a score for the same earthmoving vehicle 10 when operated by another operator, a score for a different earthmoving vehicle 10 operating at the same or a different worksite, a plan or schedule for operations at the worksite, a general standard that is derived from monitoring operation of a plurality of earthmoving vehicles 10 operating at a plurality of worksites, or another reference score. A value of another metric of operation efficiency may be calculated by operation tracking module 46.

Operation tracking module 46 may be configured to utilize one or more maps that are generated by map generation module 42, e.g., stored in map storage 44, to calculate a volume of earth that was excavated by earthmoving vehicle 10. For example, operation tracking module 46 may calculate the volume of earth that was excavated from an excavation region (e.g., a region within predefined boundaries, such as a region of a mining site, a foundation of a building or road, or other excavation) during a period of time. For example, the period of time may include a workday, shift, or another period of time. The calculation of the volume may include calculating a difference in height (e.g., as measured relative to a fixed reference elevation) at each point within the boundaries of the region between a mapped floor (e.g., vertical height of the floor at each horizontal location within the boundaries) of the region at the beginning of the period of time, and the mapped floor height at the end of the period of time. For example, the calculation may include a numerical integration of height difference over the two dimensional floor surface.

FIG. 4 schematically illustrates an example of monitoring a volume of earth that is excavated by the earthmoving vehicle shown in FIG. 1.

In FIG. 4, excavation region 50 is represented by a schematic vertical cross section of a three-dimensional excavation region 50. Excavation region 50 is bounded horizontally by boundary walls 58 (in all horizontal directions). Earthmoving vehicle 10 is tasked with excavating region floor 51 of excavation region 50.

For example, data from mapping sensors 34, navigation sensors 32, or both, may have been analyzed by map generation module 42 to generate an initial floor map 52 of region floor 51 of excavation region 50. For example, initial floor map 52 may have been generated by map generation module 42 from data that was acquired by one or both of mapping sensors 34 and navigation sensors 32 toward the end of a previous workday or other relevant period of time. Alternatively or in addition, initial floor map 52 may have been generated using data that was acquired by mapping sensors 34 at the beginning of the current workday.

As earthmoving vehicle 10 operates to excavate region floor 51 during the course of a current workday, changes to region floor 51 of excavation region 50 may be sensed and analyzed to modify the mapped height of region floor 51 from initial floor map 52. For example, at the end of the current workday (or other period), map generation module 42 may generate final floor map 54 of region floor 51.

Typically, the average height of region floor 51 as mapped by final floor map 54 is lower than the average height of region floor 51 as mapped by initial floor map 52. When earthmoving vehicle 10 is operated effectively to excavate excavation region 50, the height of region floor 51 at each horizontal point of excavation region 50 as mapped by final floor map 54 may be expected to be lower than the height of region floor 51 at that that same point as mapped by initial floor map 52. The difference in mapped heights may be assumed to be caused by an excavated volume 56 of earth that was removed from excavation region 50 by earthmoving vehicle 10 during the course of the workday (or other period). Typically, the removed earth is expected to be moved by earthmoving vehicle 10 to a location outside of excavation region 50, where the removed earth may be loaded onto transport vehicles for dumping at a dumpsite.

Operation tracking module 46 or map generation module 42 may be configured to calculate excavated volume 56 of earth that was removed from excavation region 50 by earthmoving vehicle 10. For example, a height difference 55 may be calculated at a plurality of points that are horizontally distributed across excavation region 50. Thus, excavated volume 56 may be calculated as a two-dimensional integral (e.g., calculated numerically using typical numerical integration techniques) over the two-dimensional horizontal extent of region floor 51. Other techniques for calculation of excavated volume 56 of excavated earth may be used.

The calculated excavated volume 56 of earth that is excavated from excavation region 50 by earthmoving vehicle 10 may be utilized to accurately evaluate the performance of earthmoving vehicle 10. For example, an operator of earthmoving vehicle 10 may be compensated based on calculated excavated volume 56, or an operator of excavation region 50 may be charged for services rendered by earthmoving vehicle 10 based on excavated volume 56. Similarly, excavated volume 56 as calculated for one earthmoving vehicle 10 when operated by one operator, may be compared with excavated volumes 56 that are calculated for other operators or other earthmoving vehicles 10 and utilized in evaluating performance of an operator of an earthmoving vehicle 10.

It may be noted that calculation of excavated volume 56 may represent a more reliable metric of performance of an earthmoving vehicle 10 than other commonly applied metrics. For example, in some cases, performance of an earthmoving vehicle 10 is evaluated by counting truckloads of excavated material that are removed to a dumpsite. In many cases, the number of truckloads does not accurately represent the performance of earthmoving vehicle 10. For example, a loader that loads the excavated earth onto transport vehicles (typically dump trucks) may operate at a slower rate than earthmoving vehicle 10. In some cases, the volume of earth that is loaded onto a transport vehicle by the loader may vary from truckload to truckload.

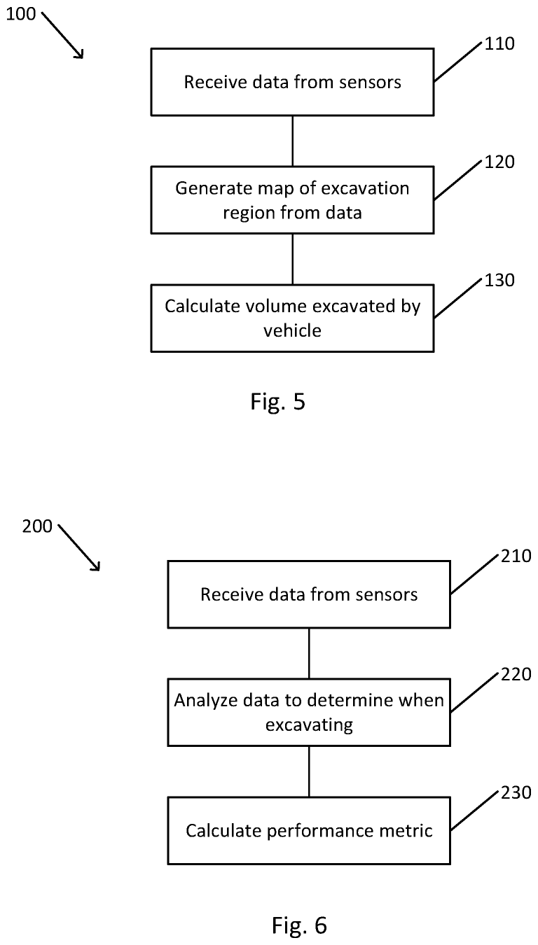

FIG. 5 is a flowchart depicting a method of operation of a vehicle monitoring system to monitor a volume of earth that is excavated by an earthmoving vehicle, in accordance with an embodiment of the invention.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Excavated volume monitoring method 100 may be executed by monitoring system processor 40 of the vehicle monitoring system. Excavated volume monitoring method 100 may be executed continuously, at predetermined times or intervals, in response to predetermined events (e.g., beginning or ending operation of earthmoving vehicle 10), in response to a command that is issued by an operator of earthmoving vehicle 10 or of the vehicle monitoring system, or otherwise.

Signals representing sensed data may be received from one or more sensors of vehicle module 18 (block 110). For example, signal data may be received from mapping sensors 34, navigation sensors 32, or both. In particular, signals may be received from one or more imaging devices 20, scanning range-finding sensors (e.g., radar, lidar, or other range-finding sensors), a GNSS receiver, an IMU, or other sensor.

The received sensor data may be analyzed to generate a three-dimensional topographical map (e.g., a relief map) of an excavation region 50 in which earthmoving vehicle 10 is performing excavation (block 120). For example, data from scanning range-finding sensors, in conjunction with data from GNSS, an IMU, or other data from navigation sensors 32 that indicates a location and orientation of earthmoving vehicle 10 relative as the range-finding sensor data is acquired, may be used to map excavation region 50. Stereo image data or other image data acquired from imaging devices 20 may be analyzed to determine locations of surfaces for generating the topographical map. RTK technology or similar techniques may be applied to data from navigation sensors 32 to generate a map of excavation region 50.

A generated map may be stored, e.g., in map storage 44.

The generated map of excavation region 50 may be utilized to calculate the volume of earth that was excavated from excavation region 50, e.g., by earthmoving vehicle 10, during a predetermined period of time (block 130). For example, a current map of excavation region 50 that was generated at the end of the period may be compared with a stored map that was generated at the beginning of the period (or at the end of a previous period when no excavation is performed between the periods). A height difference 55 between the previous map and the current map at different locations that are distributed across region floor 51 of excavation region 50 may be used to calculate (e.g., by numerical integration or otherwise) a change in the volume of excavation region 50 that is exposed by excavation.

Alternatively or in addition, changes in the height of region floor 51, e.g., relative to a previously generated reference map, may be measured continually (or at frequent intervals) as earthmoving vehicle 10 is operated to excavate excavation region 50. The measured changes may be continually summed to calculate a volume of the earth that was removed from excavation region 50. (It may be noted that as earthmoving vehicle 10 moves earth within excavation region 50, the height of a part of region 51 may temporarily increase due to temporary piling of earth until earthmoving vehicle 10 removes the pile of earth out of excavation region 50.)

The measured volume of excavated earth may be reported, e.g., via one or more output devices 37, or otherwise (e.g., to portable or fixed devices that are associated with personnel that are interested in knowing the measured volume). Monitoring changes in excavation region 50 may enable identification of characteristics of the material being excavated (e.g., hardness, size of particles or rocks, density, or other characteristics), and may enable identification of areas within excavation region 50 where excavation is difficult.

FIG. 6 is a flowchart depicting a method of operation of a vehicle monitoring system to monitor performance of an earthmoving vehicle, in accordance with an embodiment of the invention.

Performance monitoring method 200 may be executed by a processor that is associated with a vehicle monitoring system. For example, all or some operations of performance monitoring method 200 may be executed by monitoring system processor 40 of vehicle module 18 on an earthmoving vehicle 10, by a processor of monitoring system processor 40, or both. Performance monitoring method 200 may be executed continuously, at predetermined times or intervals, in response to predetermined events (e.g., beginning or ending operation of earthmoving vehicle 10), in response to a command that is issued by an operator of earthmoving vehicle 10 or of the vehicle monitoring system, or otherwise.

Data signals may be received by one or more sensors of vehicle module 18 (block 210). For example, the signal data may be received from vehicle operation sensors 22, navigation sensors 32, or both.

The received sensor data may be analyzed to determine when earthmoving vehicle 10 in engaged in excavating excavation region 50 (block 220). For example, analysis of data from one or more vehicle operation sensors 22 (e.g., together with data from navigation sensors 32) may distinguish periods of time when earthmoving vehicle 10 is actively excavating excavation region 50, e.g., moving earth within excavation region 50, moving earth from excavation region 50 to a loading site where earth that is removed from excavation region 50 is loaded onto transport vehicles, travelling back to excavation region 50 from the loading site, refueling, repairs, or other activities that may be considered (e.g., by an operator of the worksite) to be actions related to excavation of excavation region 50. Activity of earthmoving vehicle 10 that is not related to excavation may be classified as downtime for earthmoving vehicle 10.

For example, active removal or moving of earth may be indicated by one or more of engine performance of earthmoving vehicle 10 (e.g., as indicated by rate of fuel consumption, rate of engine rotation, power output, composition of exhaust gasses, or another indicator of engine performance), gear ratio, position of earthmoving blade 14 (e.g., raised or lowered), strain or stress on earthmoving blade 14, or other sensed indications of moving earth. Data from navigation sensors 32 may indicate whether earthmoving vehicle 10 is in an expected location (e.g., at excavation region 50, moving from excavation region 50 toward a loading site, or other expected location) when sensor data indicates that earthmoving vehicle 10 is engaged in moving earth.

Analysis of the sensor data and the indications of active excavation activity may yield a metric that is indicative of performance of earthmoving vehicle 10, e.g., during a period of interest (block 230). For example, a period of interest may include a period when a single operator is operating earthmoving vehicle 10, a workday or shift, or another period of time.

A performance metric may include a fraction of total operation time of earthmoving vehicle 10 during which earthmoving vehicle 10 is actively engaged in excavation-related activity, or a number excavation movements (e.g., a number of times that earthmoving vehicle 10 begins to move earth from a location within excavation region 50 to a loading location within the period of interest), a volume of the earth that is being moved (e.g., from analysis of image data that is acquired by imaging devices 20), a distance that a quantity of earth is pushed (e.g., utilizing data from navigation sensors 32), or other performance metrics based on the act of moving earth. Other performance metrics may include distance traveled in excavating excavation region 50 (e.g., indicative of operator skill), fuel consumption efficiency, or another metric. In some cases, a performance metric may be related to a volume of earth that is excavated, as calculated by excavated volume monitoring method 100. For example, the performance metric may include an amount of time or distance travelled in removing a volume of earth from excavation region 50. The performance metric may include a profile of velocity or a trajectory of movement of earthmoving vehicle 10, or another calculated result.

The calculated value of the performance metric may be reported or presented, e.g., via one or more output devices 37, or otherwise (e.g., to portable or fixed devices that are associated with personnel that are interested in knowing the value of the performance metric).

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An earthmoving vehicle performance monitoring system comprising:
one or a plurality of sensors for mounting on an earthmoving vehicle; and
a processor that is configured to:
receive sensed data generated by the sensors when mounted on the vehicle and when the vehicle is excavating in a region which the vehicle is tasked with excavating;
analyze the sensed data to update a topographical map of the region; and
analyze changes to the topographical map due to the updating to calculate a volume of earth that was excavated by the vehicle.

2. The system of claim 1, wherein the sensors are selected from a group of sensors consisting of a camera, radar scanner and lidar scanner.

3. The system of claim 2, wherein the processor is configured to analyze image data that is acquired by the sensors to determine a location or orientation of a part of the vehicle relative to a reference feature.

4. The system of claim 3, wherein the processor is configured to analyze the image data by application of simultaneous localization and mapping (SLAM) techniques to the image data.

5. The system of claim 3, wherein the processor is configured to update the topographical map by utilizing the location or orientation of the part of the vehicle and dimensions of the vehicle to calculate a height or slope of ground under the vehicle.

6. The system of claim 1, wherein the sensors include one or more navigation sensors selected from a group of sensors consisting of a global navigation satellite system (GNSS) receiver, an inertial measurement unit (IMU), a compass, a speedometer, an odometer, an altimeter and a tilt sensor.

7. The system of claim 6, wherein the processor is configured to analyze data received from the navigation sensors to determine one or more kinematic characteristics selected from a group of kinematic characteristics consisting of a location of the vehicle, an orientation of the vehicle, a velocity of the vehicle and an acceleration of the vehicle.

8. The system of claim 6, wherein the processor is configured to analyze data received from the navigation sensors to determine a location or orientation of a part of the vehicle.

9. The system of claim 8, wherein the processor is configured to update the topographical map by utilizing the determined location or orientation of the part of the vehicle and dimensions of the vehicle to calculate a height or slope of ground under the vehicle.

10. The system of claim 6, wherein the processor is configured to apply SLAM techniques to data that is received from the navigation sensors to update the topographical map.

11. The system of claim 1, wherein the sensors include one or more operation sensors that are configured to sense one or more characteristics of operation of the vehicle selected from a group of operation characteristics consisting of fuel consumption by the vehicle, rate of rotation of an engine of the vehicle, a gear ratio of a transmission of the vehicle, a steering angle of the vehicle, application of brakes of the vehicle and a position of an earthmoving blade of the vehicle.

12. The system of claim 11, wherein the processor is configured to analyze the data received from the operation sensors to determine when the vehicle is engaged in moving earth.

13. The system of claim 12, wherein the processor is configured to calculate a fraction of a time period during which the vehicle is engaged in moving earth.

14. A method for monitoring performance of an earthmoving vehicle, the method comprising:
receiving sensed data that is generated by sensors that are mounted on the vehicle when the vehicle is excavating in a region that the vehicle is tasked with excavating;
analyzing the sensed data to update a topographical map of the region; and
analyzing changes to the topographical map due to the updating to calculate a volume of earth that was excavated by the vehicle.

15. The method of claim 14, wherein receiving the sensed data comprises receiving data from sensors selected from a group of sensors consisting of a camera, radar scanner and lidar scanner.

16. The method of claim 15, wherein analyzing the sensed data to update the topographical map comprises analyzing image data that is acquired by the sensors to determine a location or orientation of a part of the vehicle relative to a reference feature, and utilizing the determined location or orientation of the part of the vehicle and dimensions of the vehicle to calculate a height or slope of ground under the vehicle.

17. The method of claim 14, wherein receiving the sensed data includes receiving the sensed data from one or more operation sensors that are configured to sense one or more characteristics of operation of the vehicle selected from a group of operation characteristics consisting of fuel consumption by the vehicle, rate of rotation of an engine of the vehicle, a gear ratio of a transmission of the vehicle, a steering angle of the vehicle, application of brakes of the vehicle and a position of an earthmoving blade of the vehicle.

18. The method of claim 17, further comprising analyzing the data received from the operation sensors to determine when the vehicle is engaged in moving earth and calculating a fraction of a time period during which the vehicle is engaged in moving earth.

19. The method of claim 14, wherein receiving the sensed data comprises receiving the sensed data from one or more navigation sensors selected from a group of sensors consisting of a GNSS receiver, an IMU, a compass, a speedometer, an odometer, an altimeter and a tilt sensor.

20. The method of claim 19, wherein analyzing the sensed data to update the topographical map comprises analyzing the data received from the navigation sensors to determine a location or orientation of a part of the vehicle and utilizing the determined location or orientation and dimensions of the vehicle to calculate a height or slope of ground under the vehicle.
